(19) United States
(12) Patent Application Publication
(10) Pub. No.: US 2013/0119620 A1
(43) Pub. Date: May 16, 2013

(54) Socket Device for use with Trailer Jacks

(71) Applicant: Shannon Smith Reynolds, Ivins, UT (US)

(72) Inventor: Shannon Smith Reynolds, Ivins, UT (US)

(21) Appl. No.: 13/672,294

(22) Filed: Nov. 8, 2012

Related U.S. Application Data
(60) Provisional application No. 61/558,138, filed on Nov. 10, 2011.

(51) Int. Cl. B66F 13/00; B25B 13/06

(52) U.S. Cl. CPC B66F 13/00; B25B 13/06
USPC 279/145; 81/121.1

(57) ABSTRACT

In an embodiment of the present invention, a socket device comprises a sleeve portion for engaging the rotatable driveshaft and a socket portion for use with an impact hammer. The sleeve portion further comprises opposing openings to engage a locking mechanism, such as a pin-lock, nut and bolt, cotter pin, or other locking device appreciated by those with skill in the art.

### CROSS-REFERENCE TO RELATED APPLICATIONS

This application claims the benefit of U.S. Provisional Application Ser. No. 61/558,138, filed on Nov. 10, 2011, and is incorporated herein by reference.

### BACKGROUND

1. Field of the Invention

The present invention relates to tractor-trailers and the manner in which they are raised and lowered. More particularly, the present invention relates to a socket device attachable to an impact wrench, also known as an impact hammer, so as to raise and lower the jacks of a trailer.

2. The Relevant Technology

The most common way to raise and lower a tractor-trailer (semi-trailer) is by manually actuating the rotatable driveshaft by using a crank arm. This method is very difficult and time-consuming, especially when raising a loaded trailer. This method is also ill-suited for older individuals, those suffering from ailments, or during times of inclement weather. The prior art has attempted to alleviate the problem by using a drill (U.S. Pat. No. 5,897,121), but fails. Standard drills generally do not have sufficient torque, so specialized drills must be used. Furthermore, the chuckable-end portion may loosen under sufficient torque, rendering the socket useless. The present invention seeks to solve these problems.

### SUMMARY OF EXAMPLE EMBODIMENTS

In an embodiment of the present invention, a socket device comprises a sleeve portion for engaging the rotatable driveshaft and a socket portion for use with an impact hammer. The sleeve portion further comprises opposing openings to engage a locking mechanism, such as a pin-lock, nut and bolt, cotter pin, or other locking device appreciated by those with skill in the art.

In another embodiment, the socket portion comprises a keyed end. In one embodiment, the keyed end engages an adapter for use with a standard impact hammer. In another embodiment, the keyed end engages a keyed impact hammer.

### BRIEF DESCRIPTION OF THE DRAWINGS

FIG. 1 is a side view of a socket device with the pin-locking mechanism removed

FIG. 2 is a side view of a socket device with the pin-locking mechanism engaged

FIG. 3 is a top view of a socket device with the pin-locking mechanism removed

FIG. 4 is a top view of a socket device with the pin-locking mechanism engaged

FIG. 5 is a bottom view of a socket device with the pin locking mechanism engaged

FIG. 6 is a perspective view of a keyed adapter

FIG. 7 is a perspective view illustrating a keyed socket, keyed adapter, and impact hammer

### DETAILED DESCRIPTION OF EXAMPLE EMBODIMENTS

The following descriptions depict only example embodiments of the invention and are not to be considered limiting of its scope.

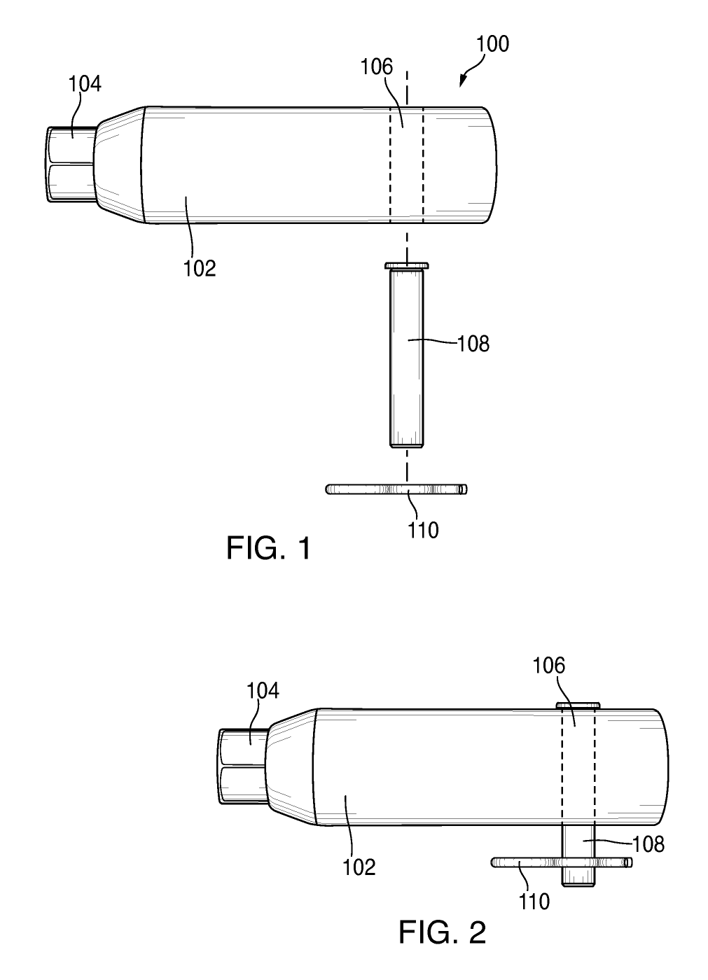

In general, an embodiment of the proposed invention relates to a socket device 100 for use with an impact wrench (not illustrated), also known as an impact hammer, so as to raise and lower the jacks on a trailer. As shown in FIG. 1, a sleeve portion 102 is connected to a socket portion 104. The sleeve portion 102 further comprising a space 106 (defined by opposing openings) to receive the locking pin 108. The locking pin 108 being locked in place with sub-locking pin 110, such as a cotter pin. While the preferred embodiment uses a locking pin 108, it will be appreciated by those with skill in the art that other locking devices, such as a nut and bolt, may be used.

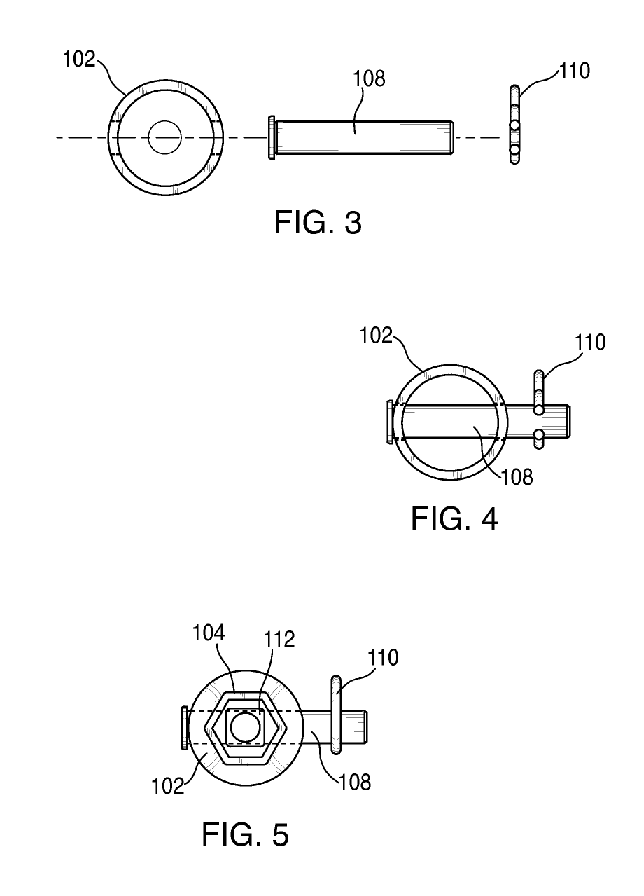

The sleeve portion 102 is sized so as to slide over and engage a rotatable driveshaft (not illustrated), and as shown in FIGS. 2-4, is locked into place using locking pin 108. An impact hammer (not illustrated) is received in the socket portion 104 through space 112, as illustrated in FIG. 5. The impact hammer then actuates the rotatable driveshaft, thereby raising or lowering the trailer jacks (not illustrated). Socket device 100 is comprised of materials suitable to withstand the torque required to raise and lower the trailer jacks. By way of example, and in no way limiting, such materials may comprise steel, iron, their derivatives or combinations, or any other material strong enough to withstand the torque required, known to those with skill in the art.

As shown in FIGS. 1,2, and 5, the socket portion 104 may also comprise an outer portion in the shape of a hexagon, or similar, to allow for easy use with other hand-actuated tools.

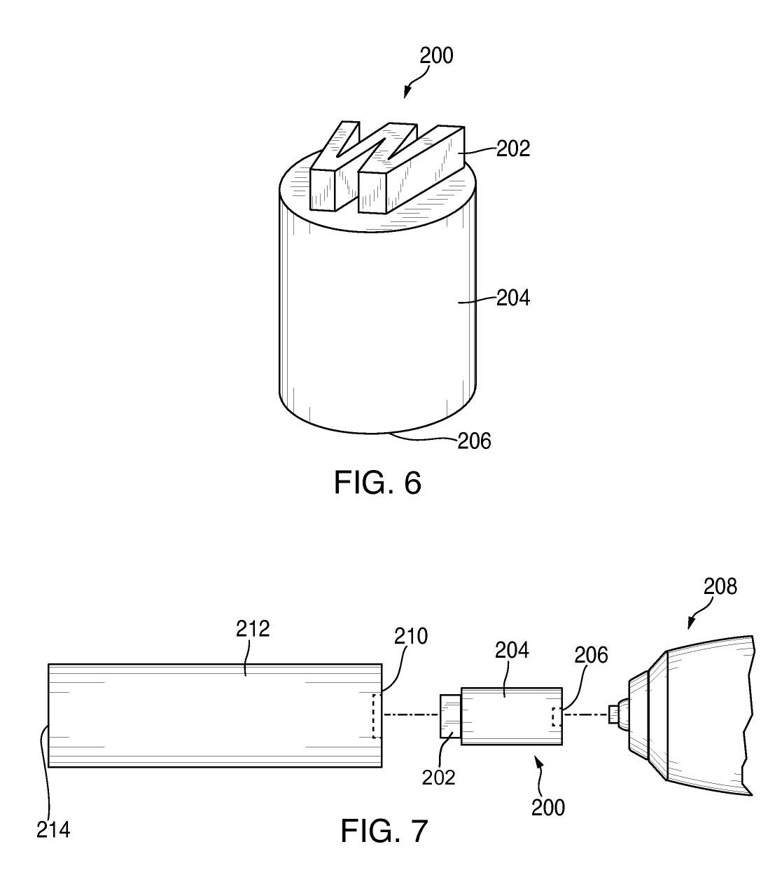

As shown in FIG. 6, another embodiment of the present invention comprises a keyed adapter 200. The keyed adapter 200 comprising a keyed portion 202, a shaft 204, and an opening 206 to receive an impact hammer. Keyed portion 202 may take a variety of shapes and sizes, so long as the torque required can be sustained. For example, the keyed portion 202 may comprise letters, such as a “W” for the brand Wal-Mart or an “S” for the brand Swift, or any other shape or size. As more fully illustrated in FIG. 7. A user engages impact hammer 208 with opening 206 of keyed adapter 200. Keyed portion 202 then engages a keyed opening 210 in keyed socket 212. Opening 214 then engages a rotatable driveshaft (not illustrated) to raise and lower trailer jacks.

In another embodiment of the present invention, impact hammer 208 may comprise a keyed portion so as to engage a keyed socket directly without use of a keyed adapter. A keyed socket is useful in preventing theft, as an ordinary impact hammer cannot be used unless one has the adapter.

While the invention has been described with respect to preferred embodiments, it is not to be considered limiting of scope. Thus, the scope of the invention is defined by the appended claims.

What is claimed is:

1. A socket device for use with the rotatable driveshaft of trailer jacks, the socket device comprising:
a sleeve portion sized to engage a rotatable driveshaft;
opposing openings in the sleeve to engage a locking mechanism; and
a socket portion to receive the end of an impact hammer.

2. The locking mechanism of claim 1 further comprising a bolt and nut.

3. The locking mechanism of claim 1 further comprising a locking pin with a cotter pin.

4. The locking mechanism of claim 1 further comprising a cotter pin.

5. A socket device for use with the rotatable driveshaft of trailer jacks, the socket device comprising:
a sleeve portion sized to engage a rotatable driveshaft;
opposing openings in the sleeve to engage a locking mechanism; and
a keyed socket portion to engage an adapter.

6. The adapter of claim 4 further comprising a male end of various configurations for engaging the keyed socket device and a female end for engaging an impact hammer.

7. A socket device for use with the rotatable driveshaft of trailer jacks, the socket device comprising:
a sleeve portion sized to engage a rotatable driveshaft;
opposing openings in the sleeve to engage a locking mechanism; and
a keyed socket portion to engage a keyed impact hammer.
